(19) United States
(12) Patent Application Publication
(10) Pub. No.: US 2017/0100721 A1
(43) Pub. Date: Apr. 13, 2017

(54) SHREDDER

(71) Applicant: Nakabayashi Co., Ltd., Osaka (JP)

(72) Inventor: Shigeru FUJIMORI, Matsue-shi (JP)

(21) Appl. No.: 15/288,294

(22) Filed: Oct. 7, 2016

(30) Foreign Application Priority Data
Oct. 9, 2015 (JP) 2015-200802

(51) Int. Cl. B02C 18/00; B02C 18/16; B02C 18/14

(52) U.S. Cl. CPC B02C 18/0007; B02C 18/142; B02C 18/16; B02C 2018/0038; B02C 2018/164

(57) ABSTRACT

A shredder includes a strip-cut shredding portion including paired disc-shaped, multi-plate rotary cutters meshing with each other to shred paper in a strip-cut direction, and a cross-cut shredding portion including a fixed cutter and a spiral rotary cutter for further shredding strip-cut waste pieces discharged from the strip-cut shredding portion in a cross-cut direction, the shredder including a unit for detecting that the spiral rotary cutter of the cross-cut shredding portion is not rotating. Shredding by the strip-cut shredding portion is stopped when the sensor unit detects that the spiral rotary cutter is not rotating.

### TECHNICAL FIELD

The present invention relates to shredding systems, and more particularly, to paper shredders having both a strip-cut shredding portion and a cross-cut shredding portion, and that include a structure for preventing shredder waste pieces from getting stuck between the strip-cut shredding portion and the cross-cut shredding portion by sensing that the cross-cut shredding portion is not operating or stops operating when such problems occur, and restrains the strip-cut shredding portion from operating.

### BACKGROUND

Conventional shredders typically include a strip-cut shredding portion and a cross-cut shredding portion on a discharge side of the strip-cut shredding portion. An example of such a shredder is shown in Japanese Patent No. 4620840, the entire contents of which are incorporated herein by reference.

As shown in FIG. 4, a main part of a conventional shredder includes a strip-cut shredding portion 20 that engages paired disc shaped multi-plate rotary cutters 21, 22 with each other to strip-cut paper passing through the engaged portion into many long and narrow noodle-shaped, strip-cut waste pieces with predetermined widths, each of the cutters 21, 22 having a large number of disc shaped cutters disposed on a rotary drive shaft, and a cross-cut shredding portion 30 which has a spiral rotary cutter 31 with spirally arranged shredding blades and a flat-blade cross-cut fixed cutter 32 facing the spiral rotary cutter 31 and which further finely cross cuts (chops) the strip-cut waste pieces discharged from the strip-cut shredding portion 20. With the shredder, it is possible to obtain finer final shredder waste pieces discharged from the cross-cut shredding portion 30, which prevents leakage of secrets in the document.

In this structure, the strip-cut shredding portion 20 and the cross-cut shredding portion 30 operate in tandem with each other. If the cross-cut shredding portion 30 does not operate or stops operating during the shredding for some reason and only the strip-cut shredding portion 20 continues to operate, the strip-cut waste pieces discharged from the strip-cut shredding portion 20 gets stuck between the strip-cut shredding portion 20 and the cross-cut shredding portion 30 and the stuck strip-cut waste pieces cannot be removed by reverse rotation of the strip-cut shredding portion 20, which makes the shredder unusable.

In this regard, power of one drive motor 40 is transmitted to the strip-cut shredding portion 20, and the strip-cut shredding portion 20 and the cross-cut shredding portion 30 are mechanically connected by gears 50 or the like in the related art as illustrated in FIG. 4. Therefore, the shredder is less likely to lapse into the state where only the strip-cut shredding portion 20 operates.

However, FIG. 2 in the aforementioned Japanese Patent No 4620840 illustrates, as an example, a structure including two drive motors which are respectively connected to a strip-cut shredding portion 8a, 8b and a cross-cut shredding portion 13. In this case, if trouble or failure of the drive motor 22 corresponding to the cross-cut shredding portion 13 or wiring for the drive motor 22 occurs, or if a control program for synchronization with the other drive motor 5 is incomplete, only the strip-cut shredding portion 8a, 8b may rotate while the cross-cut shredding portion 13 stops rotating.

In this shredder, the strip-cut shredding portion 8a, 8b and the cross-cut shredding portion 13 are caused to operate by the separate drive motors so that the cross-cut shredding portion is always rotated normally to reliably discharge the shredder waste pieces whether the strip-cut shredding portion is rotating normally or reversely. This art does not expect that the cross-cut shredding portion 13 stops rotating and does not consider stopping rotation of the strip-cut shredding portion 8a, 8b in this case. This art is not intended to prevent the above described paper jam caused by the operation of only the strip-cut shredding portion 20.

### SUMMARY

The disclosed shredder has been developed in view of the above-described problems and it is an object thereof to provide a shredder in which a paper jam does not occur when a cross-cut shredding portion becomes unable to rotate due to a jam or other malfunction.

In order to achieve the above described object, an embodiment of the present shredder provides a strip-cut shredding portion including paired, disc-shaped multi-plate rotary cutters that engage each other to shred paper in a strip-cut direction, and a cross-cut shredding portion including a fixed cutter and a spiral rotary cutter for further shredding strip-cut waste pieces discharged from the strip-cut shredding portion in a cross-cut direction, the shredder including a unit for sensing when the spiral rotary cutter of the cross-cut shredding portion is not rotating. This sensor unit stops shredding by the strip-cut shredding portion when the sensor unit detects that the spiral rotary cutter is not rotating.

With this structure, the strip-cut shredding portion does not continue to operate when the spiral rotary cutter is detected as not rotating, and therefore a paper jam is prevented from occurring between the strip-cut shredding portion and the cross-cut shredding portion. The stoppage of shredding by the strip-cut shredding portion may occur not only an interruption in the shredding operation, but also when waiting for shredding to start. Moreover, the stoppage may also include rotation of the strip-cut shredding portion in the reverse direction from shredding directions (i.e., reverse rotation).

In a specific embodiment, the disclosed shredder further includes a strip-cut shredding drive motor for rotating the disc shaped multi-plate rotary cutters, and a separate cross-cut shredding drive motor for rotating the spiral rotary cutter. Operation of the strip-cut shredding drive motor is stopped so that the strip-cut shredding portion does not carry out shredding when no rotation of the spiral rotary cutter is detected. With this structure, the strip-cut shredding drive motor is controlled to rotate the disc-shaped, multi-plate rotary cutters of the strip-shredding portion in reverse directions from shredding direction when non-rotation of the spiral rotary cutter of the cross-cut shredding portion is detected.

The sensor unit, which senses that the spiral rotary cutter is not rotating, may be formed by a combination of an encoder disc integrally provided to a rotary shaft of the spiral rotary cutter and an encoder sensor corresponding to the encoder disc.

The encoder disc may have a gear shape with a plurality of recessed portions and a plurality of protruding portions formed alternately at an outer periphery of the disc in a circumferential direction. The encoder sensor may include a photosensor. A typical photosensor is a transmission-type photosensor (photoelectric sensor) including a phototransmitter and a photoreceiver disposed on opposite sides of the outer periphery of the disc so that light is intercepted by the protruding portions and that the light passes through the recessed portions. However, other types of photosensors may be employed. If the photosensor is a transmission-type photosensor, it is preferable to employ a groove-shaped or angular U-shaped sensor in which a phototransmitter and a photoreceiver with optical axis aligned with each other are integrated with each other in advance.

Though the respective shredding portions and the respective motors may be connected by gears, sprockets may be provided to rotary shafts of the disc shaped multi-plate rotary cutter and the spiral rotary cutter and drive shafts of the respective drive motors, and the drive motors may be respectively connected to the disc-shaped, multi-plate rotary cutter and the spiral rotary cutter by chains corresponding to the sprockets.

According to one embodiment of the present invention, when the cross-cut shredding portion does not function due a jam or malfunction, rotation (no rotation) of the cross-cut shredding portion is detected and operation of the upstream strip-cut shredding portion is stopped. Therefore, the strip-cut waste pieces are not discharged from the strip-cut shredding portion in an unfinished state. In this way, a paper jam is avoided and it is possible to swiftly inspect the shredder and fix the malfunction.

### BRIEF DESCRIPTION OF THE DRAWINGS

FIG. 1 is a schematic plan view of a main part of an embodiment of the disclosed shredder;

FIG. 2 is a side schematic view of the shredder of FIG. 1;

FIGS. 3A and 3B are schematic views of a sensor portion of the shredder of FIG. 1, wherein FIG. 3A is a side schematic view and FIG. 3B is a front schematic view; and

FIG. 4 is a plan schematic view of a main part of a prior art shredder.

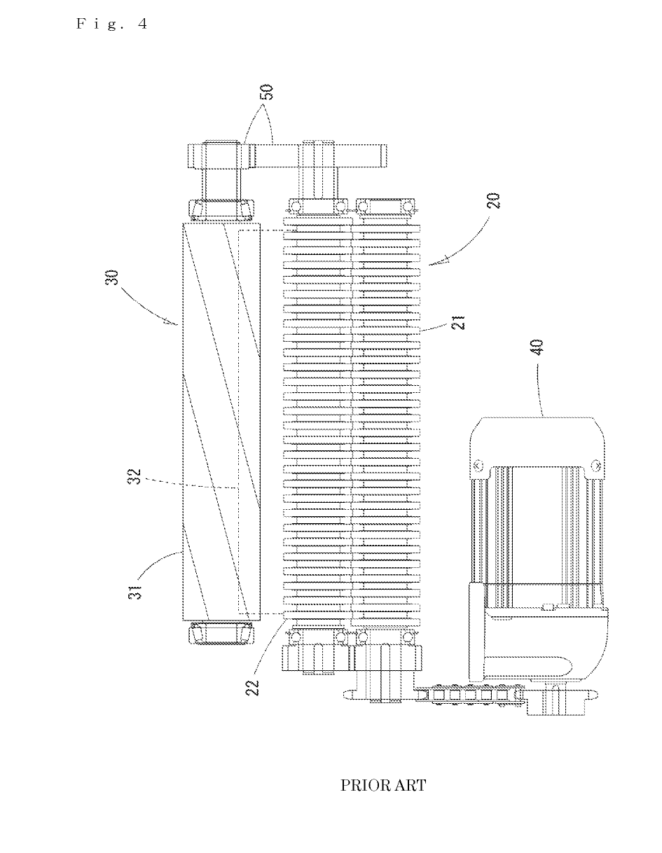

### DETAILED DESCRIPTION

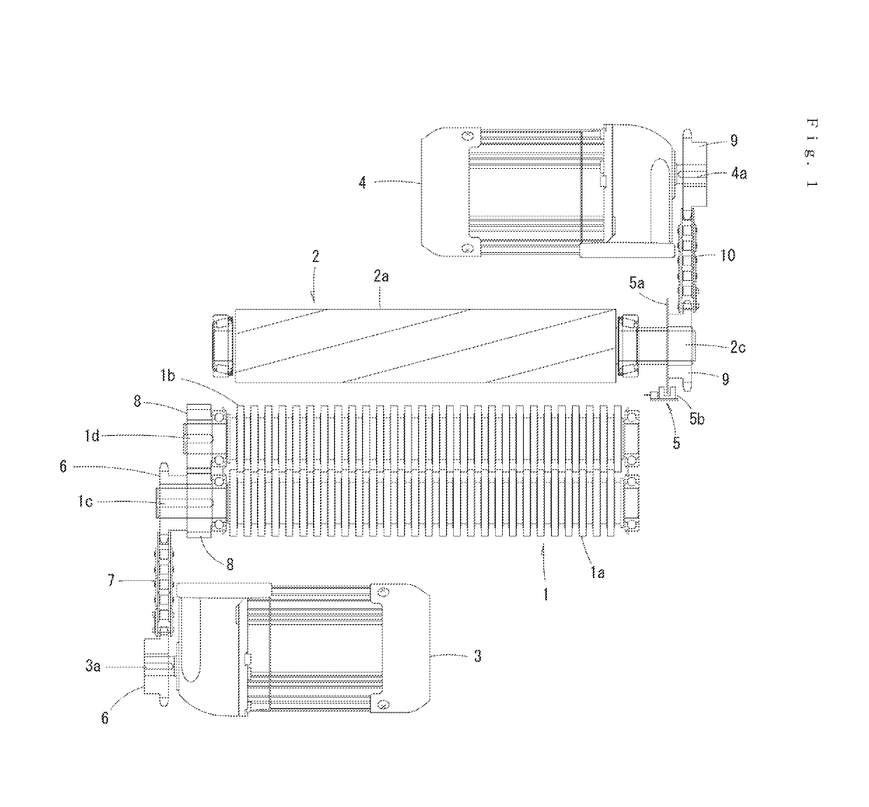

As shown in FIG. 1, an embodiment of the disclosed shredder may include a strip-cut shredding portion 1, a cross-cut shredding portion 2, a strip-cut shredding drive motor 3, a cross-cut shredding drive motor 4, and a sensor unit 5.

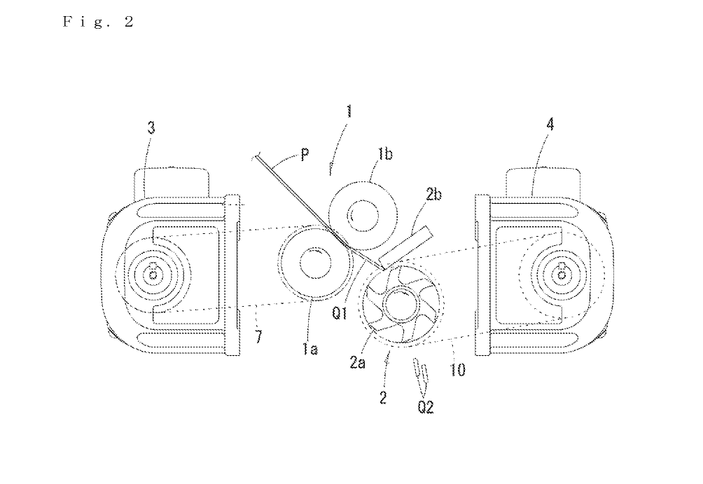

The strip-cut shredding portion 1 is formed by disposing paired, disc-shaped multi-plate rotary cutters 1a, 1b so that the cutters 1a, 1b rotate in directions for feeding paper P (see FIG. 2) with their blades meshing with each other. The strip-cut shredding portion 1 shreds the paper P passing through the engaged portion in a strip-cut direction into noodle-shaped long and narrow strip-cut waste pieces Q1 as illustrated in FIG. 2.

In the strip-cut shredding portion 1, a rotary shaft 1c of one of the disc-shaped, multi-plate rotary cutters 1a and a drive shaft 3a of the strip-cut shredding drive motor 3 are each provided with a sprocket 6. A corresponding sprocket chain 7 is put on the sprockets 6 so as to transmit a drive force of the motor 3 to the disc-shaped, multi-plate rotary cutter 1a to rotate the cutter 1a. The rotary shafts 1c, 1d of the paired disc-shaped, multi-plate rotary cutters 1a, 1b are provided with gears 8. The gears 8 mesh with each other to thereby cause the disc-shaped, multi-plate rotary cutters 1a, 1b to rotate synchronously in opposite directions. The disc-shaped, multi-plate rotary cutters 1a, 1b can be rotated in a first, normal direction to shred the paper P and also in a second, reverse direction by control of the rotating direction of the shaft 3a of the motor 3.

The cross-cut shredding portion 2 includes a spiral rotary cutter 2a having a plurality of cutting edges, and a fixed cutter 2b having a cutting edge positioned on an orbit of rotation of the cutter 2a as illustrated in FIG. 2. The cross-cut shredding portion 2 further shreds in a cross-cut direction (cross cuts) the strip-cut waste pieces Q1 discharged from the strip-cut shredding portion 1 by means of the spiral rotary cutter 2a and the fixed cutter 2b.

In this cross-cut shredding portion 2, a rotary shaft 2c of the spiral rotary cutter 2a and a drive shaft 4a of the cross-cut shredding drive motor 4 are each provided with a sprocket 9 and a corresponding sprocket chain 10 is put on the sprockets 9 so as to transmit a drive force of the motor 4 to the spiral rotary cutter 2a to rotate the cutter 2a. The spiral rotary cutter 2a is rotated only in the normal direction for cross-cutting the strip-cut waste pieces Q1 discharged from the strip-cut shredding portion 1 and need not be rotated in a reverse direction in a normal situation.

The cross-cut shredding portion 2 is provided with a sensor unit 5 for detecting whether the spiral rotary cutter 2a is rotating.

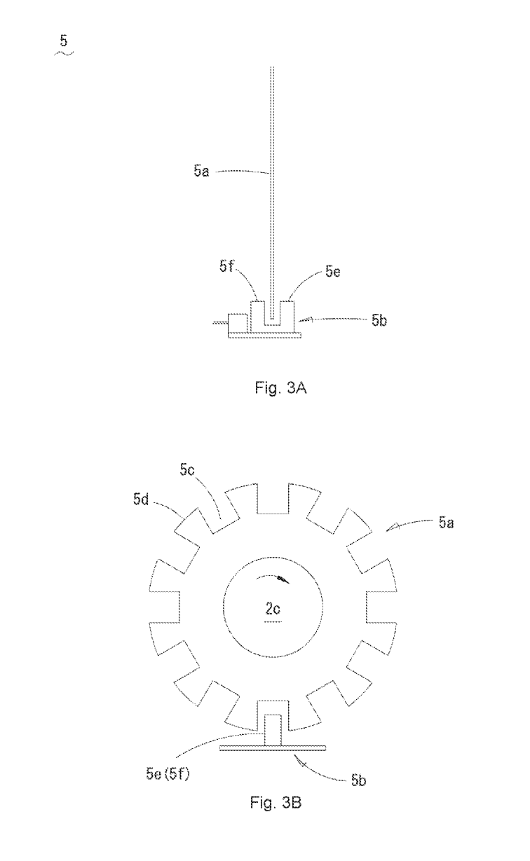

The sensor unit 5 is formed by a combination of an encoder disc 5a, which is fixed to the rotary shaft 2c of the spiral rotary cutter 2a, and an encoder sensor 5b. As illustrated in FIG. 3B, the encoder disc 5a has a gear shape with a plurality of recessed portions 5c and a plurality of protruding portions 5d formed alternately at an outer periphery of the disc in a circumferential direction. On the other hand, the encoder sensor 5b is formed of a transmission-type photosensor including a phototransmitter 5e and a photoreceiver 5f disposed, facing each other, on opposite sides of the encoder disc 5a. Light is allowed to pass when the recessed portion 5c is positioned between the phototransmitter 5e and the photoreceiver 5f. Light is blocked when the protruding portion 5d is positioned between them.

Therefore, when the light is intermittently input to the photoreceiver 5f for a certain amount of time, the spiral rotary cutter 2a is determined to be rotating, and the sensor unit 5 can detect that the spiral rotary cutter 2a is rotating, i.e., that the cross-cut shredding portion 2 is operating in a normal way. On the other hand, when light from the phototransmitter 5e is not received by the photoreceiver 5f, or light from the phototransmitter 5e is received by the photoreceiver without interruption, the spiral rotary cutter 2a is determined not to be rotating and the sensor unit 5 can detect that the spiral rotary cutter 2a is not rotating.

With the shredder according to the embodiment, when a main body (not shown) is powered on, the sensor unit 5 operates to start monitoring the spiral rotary cutter 2a for rotation. When a start button (not shown) is actually pushed for shredding of the paper P, the strip-cut shredding drive motor 3 and the cross-cut shredding drive motor 4 are driven to simultaneously rotate the disc-shaped, multi-plate rotary cutters 1a, 1b and the spiral rotary cutter 2a to simultaneously carry out strip-cut shredding and cross-cut shredding next.

In contrast to such normal operation, when the sensor unit 5 detects that the spiral rotary cutter 2a is not rotating for some reason even though the start button has been pushed, a control circuit (not shown) stops supply of electric power to the strip-cut shredding drive motor 3 to restrain the disc shaped multi-plate rotary cutters 1a, 1b from rotating to cancel operation for the strip-cut shredding.

Such a cancellation is made not only at the start of shredding but also when no rotation of the spiral rotary cutter 2a is detected in the middle of the normal operation.

Therefore, it is possible to prevent the strip-cut waste pieces Q1 discharged from the strip-cut shredding portion 1 from getting stuck between the strip-cut shredding portion 1 and the cross-cut shredding portion 2 due to the operation of only the strip-cut shredding portion 1 in which only the disc-shaped, multi-plate rotary cutters 1a, 1b rotate. In this way, when failure of the motor 4 or trouble of wiring for the cross-cut shredding portion 2 occurs and the cross-cut shredding portion 2 does not operate in a normal way, it is possible to prevent further trouble, e.g., occurrence of a paper jam.

While the forms of apparatus and methods herein described constitute preferred embodiments of this invention, it is to be understood that the invention is not limited the these precise forms of methods and apparatus, and that changes may be made therein without departing from the scope of the invention.

What is claimed is:

1. A shredder comprising:
a strip-cut shredding portion including paired disc-shaped, multi-plate rotary cutters to mesh with each other to shred paper in a strip-cut direction;
a cross-cut shredding portion including a fixed cutter and a spiral rotary cutter for shredding strip-cut waste pieces discharged from the strip-cut shredding portion in a cross-cut direction; and
a sensor unit for detecting that the spiral rotary cutter of the cross-cut shredding portion is not rotating, wherein shredding by the strip-cut shredding portion is stopped when the sensor unit detects that the spiral rotary cutter is not rotating.

2. The shredder according to claim 1, further comprising:
a strip-cut shredding drive motor for rotating the disc-shaped, multi-plate rotary cutters; and
a cross-cut shredding drive motor for rotating the spiral rotary cutter,
the motors provided separately from each other,
wherein driving of the strip-cut shredding drive motor is stopped so that the strip-cut shredding portion does not carry out the shredding when no rotation of the spiral rotary cutter is detected.

3. The shredder according to claim 2, wherein the strip-cut shredding drive motor is controlled to rotate the disc-shaped, multi-plate rotary cutters of the strip-shredding portion in a reverse direction from shredding directions when non-rotation of the spiral rotary cutter of the cross-cut shredding portion is detected.

4. The shredder according to claim 1, wherein the sensor unit for detecting that the spiral rotary cutter is not rotating is formed by a combination of an encoder disc fixed to a rotary shaft of the spiral rotary cutter paired with an encoder sensor.

5. The shredder according to claim 4, wherein
the encoder disc has a shape of a gear with a plurality of recessed portions and a plurality of protruding portions formed alternately at an outer periphery of the disc in a circumferential direction, and
the encoder sensor is a photosensor including a phototransmitter and a photoreceiver disposed on opposite sides of the outer periphery of the disc so that light from the phototransmitter is blocked from reaching the photoreceiver by the protruding portions and light from the phototransmitter passes through the recessed portions to the photoreceiver.

6. The shredder according to claim 2, wherein
sprockets are mounted on rotary shafts of the disc-shaped, multi-plate rotary cutter and the spiral rotary cutter and drive shafts of the respective drive motors, and
the drive motors are respectively connected to the disc-shaped, multi-plate rotary cutter and the spiral rotary cutter by chains corresponding to the sprockets.
